(19) United States
(12) Patent Application Publication
(10) Pub. No.: US 2003/0169898 A1
(43) Pub. Date: Sep. 11, 2003

(54) Headphone device

(75) Inventor: Tetsuya Arasawa, Yamagata-ken (JP)

Correspondence Address: ARENT FOX KINTNER PLOTKIN & KAHN, PLLC, Suite 600, 1050 Connecticut Avenue, Washington, DC, 20036-5339, US

(73) Assignee: Pioneer Corporation

(21) Appl. No.: 10/274,147

(22) Filed: Oct. 21, 2002

(30) Foreign Application Priority Data
Oct. 23, 2001 (JP) 2001-324366

(51) Int. Cl. H04R 25/00

(52) U.S. Cl. 381/383; 381/370

(57) ABSTRACT

A headphone device having a constant pressing force adjustable in accordance with the size of individual wearer's head when the headphone units thereof are attached to wearer's ears. A force for pressing the headphone units against the wearer's ears is produced by means of a torsion elasticity of an elastic band. The elastic band is a molded resin member having an approximately C-shaped cross-section, and provided with a pair of curved elements in the vicinity of couplings each located between the elastic band and a headphone unit. A twist is applied to the elastic band by virtue of displacement of the headphone units in a direction of the units facing each other.

### BACKGROUND OF THE INVENTION

This invention relates to a headphone device used as an output device for audio apparatus, more particularly, to a headphone device including an elastic band provided for pressing right and left headphone units against the corresponding ears of a wearer.

The present application claims priority from Japanese Application No. 2001-324366, the disclosure of which is incorporated herein by reference for all purposes.

Headphones serve as an output device for audio apparatus for converting an electric signal to sound for output, and includes, at least, a pair of right and left headphone units which are held so as to face the corresponding ears of a wearer in use, and an elastic band providing the coupling between the headphone units and pressing the headphone units against the wearer's ears.

The elastic band is a curved elastic member, including a headband style supported on the head of a wearer, an under-band style passing under the jaw of a wearer, and a neckband style passing behind the neck or head of a wearer. FIG. 6 is a diagram for illustrating an example of conventional headphone devices employing the neckband style elastic band. As show in the drawing, a headphone device 11 includes an elastic band 20 which provides the coupling between a pair of right and left headphone units 12 and produces a lateral pressure toward the ears on the headphone units 12. Each of the headphone units 12 includes a casing 13 containing a transducer for converting an electric signal to sound, and an ear-pad 14 which is made of a foamed polyurethane or the like and covers a side portion 13a and an ear-facing portion of the casing 13.

The elastic band 20 is composed of an elastic member having appropriate cross-sectional shape and bent into an approximately U-shaped configuration. The two headphone units 12 are pressed against the wearer's cars by an elastic rebound force of the band 20 extending from its bent position. An element 20a connected with the casing 13 has a fluctuation property or a flexibility, thereby providing an appropriate pressing force regardless of an angle of the headphone unit 12 in contact with the wearer's ear An ear-hooking element 21 is provided around each casing 13 in order to prevent the headphone unit 12 from slipping off the ear.

The conventional headphone device as described above is usually designed such that when in use, the bent elastic band is extended open and then the headphone units mounted at both ends of the elastic band are attached to the wearer's cars. At this time, a force will be generated for pressing the headphone units against the respective ears (pressing force) However, with such an elastic band having only one size, the elastic band's extending amount, i.e., an elastic displacement of the elastic band will vary corresponding to the size of each wearer's head or face. As a result, it is impossible to provide an appropriate pressing force for each wearer, leading to a problem that an insufficient pressing force acts on a wearer's head or face having a small size, while an unduly large pressing force acts on a wearer's head of face having a larger size (unless the elastic bands are provided in various sizes in accordance with the sizes of various wearer's heads or faces.

In order to prevent leakage of sound and also to allow the user to comfortably wear the headphone device, it is needed to establish an optimum pressing force for each individual user. However, the elastic bands are typically manufactured with one size in view of manufacturing costs, hence making it impossible to provide an optimum pressing force for each individual user.

The headphone device using an elastic band (particularly, the aforementioned under-band or neckband style) may slip off the ears in use when the pressing force of the elastic band is decreased. Hence, it is necessary to additionally provide ear-hooking elements to prevent the headphone device from falling off the ears. As a result, manufacturing cost is high.

### SUMMARY OF THE INVENTION

The present invention has been made to address the circumstances as described above, and therefore it is an object of the invention to provide a head phone device capable of adjusting a pressing force according to the size of an individual wearer's head when the headphone units thereof are attached to the wearer's ears (even if the headphone devices are manufactured with only one size), and having no likelihood that the headphone units slip off the wearer's ears even when the head phone device is the so-called under-band style or the so-called neckband style. Another object of the invention is to manufacture such headphone devices at a low cost.

To attain the above object, a headphone device according to the present invention has the following features.

According to a first aspect of the invention, there is provided a headphone device including a pair of right and left headphone units, comprising: an elastic band providing a coupling between the pair of headphone units to press each of the headphone units against a corresponding ear of a wearer, characterized in that: the elastic band is provided with a torsional elasticity to allow the elastic band to be twisted, so as to enable the headphone units to have a face-to-face contact with the ears of the wearer.

According to a second aspect of the invention, at least a part of the elastic band is formed with a member having a C-shaped cross-section.

According to a third aspect of the invention, at least a part of the elastic band comprises a core member and a flexible member covering the core member.

According to a fourth aspect of the invention, the elastic band has curved elements each extending curvedly in the vicinity of a coupling to one of the headphone units.

According to a fifth aspect of the invention, the curved element serves as an ear-hooking element.

According to a sixth aspect of the invention, the elastic band is freely foldable.

According to the above features, the present invention has the following operations and advantages.

According to the first aspect of the invention, a torsional elasticity is imparted to the elastic band. The elastic band is twisted to allow the headphone units to make face-to-face contact with wearer's ears, whereupon the torsional elasticity of the twisted elastic band produces a pressing force required for pressing the headphone units against the corresponding ears. In this way, the pressing force may be determined by the amount of twisting the elastic band. Accordingly, by appropriately adjusting the headphone units before the elastic band is twisted in a direction of the headphone units facing each other, it is possible to set a constant pressing force regardless of the size of the wearer's head or face. As a result, the present invention provides a headphone device capable of preventing leakage of sound and slipping-off of the headphone device, thereby successfully providing a comfortable wearing feeling for all individual persons with only one size of the headphone devices. Further, the mass production of one-size headphone devices allows a significant reduction in manufacturing cost.

According to the second aspect of the invention, since at least a part of the elastic band is formed with a member having C-shaped cross-section, a required amount of elastic torsion is produced on the elastic band to provide an adequate pressing force.

According to the third aspect of the invention, at least a part of the elastic band is constructed with the core member and the flexible member covering the core member. Therefore, an optimum pressing force may be obtained by means of an elasticity combination of the core member and the flexible member. In addition, the flexible member covers the part of the elastic band that comes in contact with an area around an ear, resulting in a satisfactory wear comfort.

According to the fifth aspect of the invention, the elastic band has the curved elements each extending curvedly around a coupling to a headphone unit. Such an elastic band is provided with a large amount of torsion by virtue of the curved elements, thus providing an adequate pressing force. Further, each of the curved element is hooked on the wearer's ear to serve as the ear-hooking element, thereby preventing the headphone device from slipping off the wearer's ears without providing an extra ear-hooking member.

According to the sixth aspect of the invention, the elastic band having the above advantages has been designed to be foldable so that it can be easily carried along.

The present invention configured as described above allows the provision of a headphone device which is capable of having a pressing force adjusted corresponding to the size of individual wearer's head when the headphone units thereof are attached to wearer's ears (even if the headphone devices are manufactured with only one size), and can eliminate the likelihood that the headphone units will slip off the wearer's ears (even when the headphone device is the so-called under-band style or the so-called neckband style. Further, such an improved headphone device can be manufactured at a low cost.

These and other objects and features of the present invention will become more apparent from the following detailed description with reference to the accompanying drawings.

### BRIEF DESCRIPTION OF THE DRAWINGS

FIG. 1A is a plan view illustrating an outer appearance of a headphone device formed according to a preferred embodiment of the present invention.

FIG. 1B is a side view illustrating the outer appearance of the headphone device of the preferred embodiment.

FIG. 2 is a sectional view taken along the A-A line in FIG. 1A.

FIG. 3A is an explanatory plan view illustrating the operation of the headphone device of the preferred embodiment.

FIG. 3B is a partially sectional view illustrating the operation of the headphone device of the preferred embodiment.

FIG. 4 is an explanatory view illustrating a pattern of using the headphone device formed according to the preferred embodiment.

FIG. 5 is an explanatory view illustrating how to close up the headphone device formed according to the preferred embodiment.

FIG. 6 is an explanatory view illustrating a headphone device formed according to a prior art.

### DETAILED DESCRIPTION OF THE PREFERRED EMBODIMENT

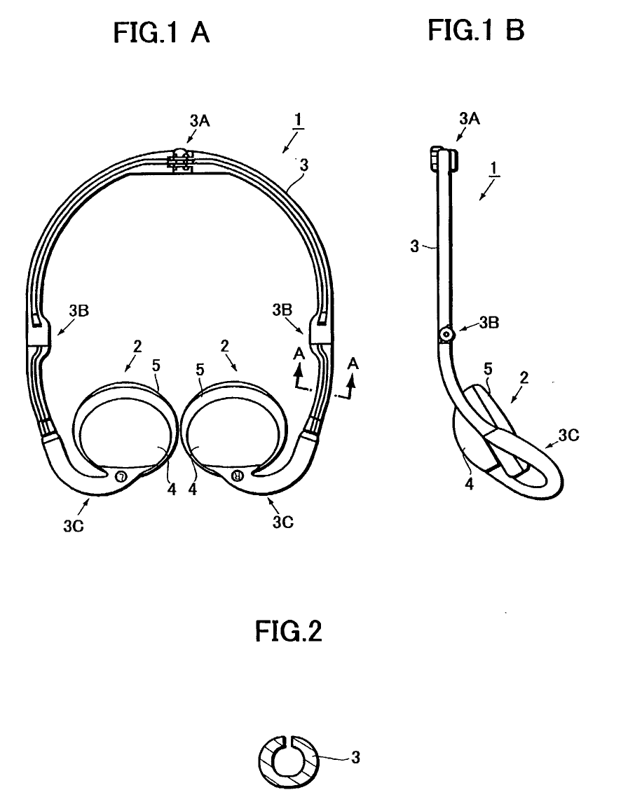

A preferred embodiment according to the present invention will be described hereinafter with reference to the accompanying drawings. FIGS. 1A and 1B illustrate appearance of a headphone device formed as an embodiment according to the present invention. In detail, FIG. 1A is a plan view and FIG. 1B is a side view. FIG. 2 is a sectional view taken along the A-A line in FIG. 1A.

The headphone device 1 includes a pair of right and left headphone units 2, and an elastic band 3 having an approximately U-shaped configuration and coupled to the headphone units 2 at its both ends. Each of the headphone units 2 includes a casing 4 containing a transducer for converting an audio electric signal transmitted here to by wire (not show) or wireless manner into sound, and an ear pad 5 covering a side portion and an ear-facing portion of the casing 4. The elastic band 3 includes a central-positioned folding element 3A and two side-positioned folding elements 3B which make the elastic band 3 foldable.

With regard to such headphone device 1, the elastic band 3 is a molded resin member and has an approximately C-shaped cross-section as illustrated in FIG. 2, and further includes a curved element 3C formed in the vicinity of a coupling part in which the band 3 is coupled to each headphone unit 2. Each of the headphone units 2 is coupled to the curved element 3C in a manner such that they are oriented approximately toward the plane formed by the U-shaped elastic band 3.

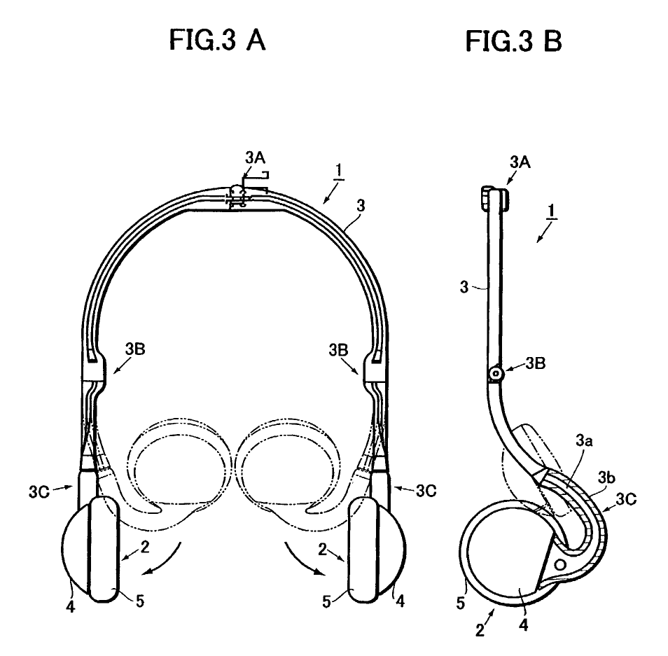

The operation of the headphone device 1 having the above construction will be described in the following with reference to FIG. 3A (a plan view illustrating a pattern for using the headphone device 1) and FIG. 3B (a partially sectional side view). With the illustrated headphone device, a torsional elasticity is imparted to the elastic band 3 on the whole because the band 3 is molded of resin with approximately C-shaped cross-section. Providing the curved elements 3C for coupling with each headphone unit 2 allows the elastic band 3 to be readily twisted. In this way, the headphone units 2 coupled to the leading ends of the respective curved elements 3C may be moved in a direction indicated by the arrow in FIG. 3A, thereby rendering the ear-facing portions of the headphone units 2 to face each other. Therefore, the elastic band 3 may be twisted to cause the headphone units 2 to come in face-to-face contact with wearer's ears, so that the torsional elasticity of the elastic band 3 generates a pressing force to press the headphone units 2 against the corresponding ears of the wearer.

The pressing force provided in this manner is generated in accordance with the amount of torsion produced when the headphone units 2 are displaced from the position illustrated in FIG. 1 to the position illustrated in FIG. 3A. Hence, a desired pressing force can be established by adjusting mounting conditions when attaching the headphone units 2 to the elastic band 3 before being twisted as illustrated in FIG. 1, or alternatively, by adjusting a torsional rigidity of the elastic band 3. When a user wears the headphone device 1 in his or her actual use, he/she opens the elastic band 3 to enlarge the space between the headphone units 2 in accordance with a size of his/her head or face. However, the pressing force against the wearer's ears is generated mainly by the above torsional elasticity, thus allowing the setting of an approximately constant pressing force regardless of the size of the head or face of a user.

Twisting the curved element 3C itself also contributes to the generation of the aforementioned pressing force. Therefore, as illustrated in the partially sectional view in FIG. 3B, the curved element 3C is constructed with a core member 3a and a flexible member 3b covering the core member 3a. An outside diameter of the core member 3a and materials of the flexible member 3b are appropriately selected. An elasticity combination of the selected core member 3a and flexible member 3b allows generating of an optimum pressing force. An elastomer or the like can be used as a material for the flexible member 3b having such elasticity.

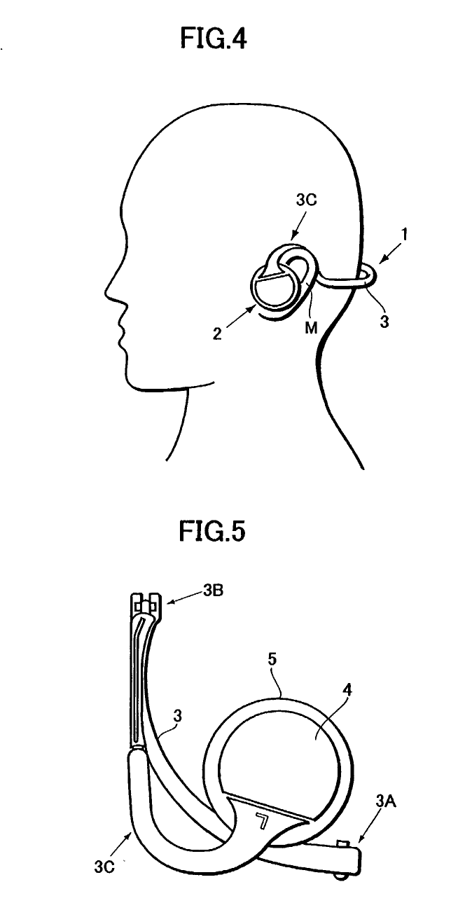

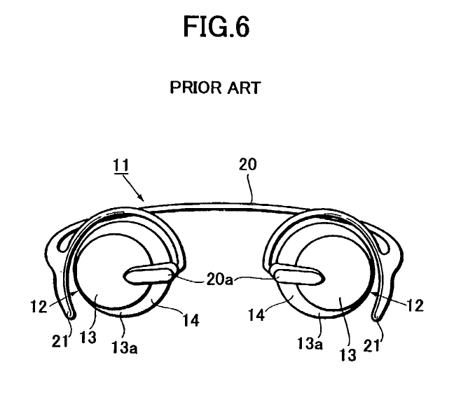

FIG. 4 is an explanatory view illustrating pattern of using the headphone device 1, taking as an example the case where the headphone device 1 employs the neckband style and the curved element 3C is hooked on an auricle M of the wearer to serve as an ear-hooking element. In this case, the flexible member 3b of the curved element 3C is in soft contact with the ear and the corresponding temporal region of the wearer to provide satisfactory wearer comfort for the wearer. Further, the curved element 3C, which is part of the elastic band 3, also-serves as the ear-hooking element, so that it becomes possible to realize a stable and reliable wearing of the headphone device without having to worry that it will slip off the ears. Moreover, such an improved headphone device can be manufactured at a lower cost than the above-described conventional headphone device which needs an ear-hooking element or the like for preventing the headphone device from slipping off the ears.

FIG. 5 is an explanatory view illustrating a pattern for closing the headphone device 1. As described earlier, the elastic band 3 of the headphone device 1 is provided with the central folding element 3A and the left and right side folding elements 3B. Additionally, the plane defined by the elastic band 3 bent in the approximate U shape is roughly flush with the ear-facing portions of the headphone units 2. Hence, by bending the folding elements 3A and 3B, the headphone device 1 can be reduced in size for storage as illustrated in FIG. 5. This design enables the user to handle the headphone device 1 as a portable type and easily store the folded headphone device 1 into a pocket of a jacket, for example.

According to the embodiment of the headphone device 1 as described thus far, by twisting the elastic band 3 provided with the torsion elasticity to allow the headphone units 2 to face the wearer's ears, the torsion elasticity of the elastic band 3 generates a pressing force for pressing the headphone units 2 against the ears. Therefore, the pressing force determined by the amount of twisting the elastic band 3 is adjusted as appropriate, thereby allowing the setting of a constant pressing force regardless of the size of the head or face of the wearer. As a result, it is possible to provide headphone devices capable of preventing leakage of sound and slipping-off of the headphone device from the wearer's ears and also capable of providing a satisfactory wear comfort for all individual persons with only one size of the headphone device. Further, the mass production of one-size headphone devices allows a significant reduction in manufacturing cost.

The foregoing embodiment has described the so-called neckband style headphone device by way of example, but the present invention described herein is not limited thereto, but also applicable to the so-called headband style headphone device, so-called under-band style headphone device and the like.

The terms and description used herein are set forth by way of illustration only and are not meant as limitations. Those skilled in the art will recognize that numerous variations are possible within the spirit and scope of the invention as defined in the following claims.

What is claimed is:

1. A headphone device including a pair of right and left headphone units, comprising:
an elastic band providing a coupling between the pair of headphone units to press each of the headphone units against a corresponding ear of a wearer, characterized in that:
the elastic band is provided with a torsional elasticity to allow the elastic band to be twisted, so as to enable the headphone units to have a face-to-face contact with the ears of the wearer.

2. A headphone device according to claim 1, wherein at least a part of said elastic band is formed with a member having a C-shaped cross-section.

3. A headphone device according to claim 1, wherein at least a part of said elastic band comprises a core member and a flexible member covering the core member.

4. A headphone device according to claim 1, wherein said elastic band has curved elements each extending curvedly in the vicinity of a coupling to one of the headphone units.

5. A headphone device according to claim 4, wherein said curved element serves as an ear-hooking element.

6. A headphone device according to claim 1, wherein said elastic band is freely foldable.

7. A headphone device according to claim 2, wherein said elastic band has curved elements each extending curvedly in the vicinity of a coupling to one of the headphone units.

8. A headphone device according to claim 3, wherein said elastic band has curved elements each extending curvedly in the vicinity of a coupling to one of the headphone units.

9. A headphone device according to claim 2, wherein said elastic band is freely foldable.

10. A headphone device according to claim 3, wherein said elastic band is freely foldable.

11. A headphone device according to claim 4, wherein said elastic band is freely foldable.

12. A headphone device according to claim 5, wherein said elastic band is freely foldable.
